(19) United States
(12) Patent Application Publication
(10) Pub. No.: US 2026/0326571 A1
(43) Pub. Date: Oct. 22, 2026

(54) METHOD FOR CONTROLLING STRUCTURAL BATTERY FOR ELECTRIC VEHICLE

(71) Applicants: Hyundai Motor Company, Seoul (KR); Kia Corporation, Seoul (KR)

(72) Inventor: Won Ki Song, Hwaseong-si (KR)

(21) Appl. No.: 19/437,616

(22) Filed: Dec. 31, 2025

(30) Foreign Application Priority Data
Apr. 21, 2025 (KR) 10-2025-0051775

(51) Int. Cl. B60L 3/00; B60L 58/10; H01M 10/44; H01M 10/48; H01M 50/293

(52) U.S. Cl. CPC B60L 3/0046; B60L 58/10; H01M 10/441; H01M 10/482; H01M 50/293; B60L 2240/545; B60L 2240/547; B60L 2240/549; H01M 2220/20

(57) ABSTRACT

A method for controlling a structural battery for an electric vehicle according to an embodiment representing a method for controlling a center floor structural battery configured with structural battery modules applied to a vehicle includes: charging the respective structural battery modules; monitoring whether the respective structural battery modules are damaged; independently controlling charging and discharging of the respective structural battery modules depending on whether the respective structural battery modules are damaged; supplying electric power of the respective structural battery modules to a load device of the vehicle; monitoring whether the load device is damaged; and blocking a current flow to the respective structural battery modules when the load device is damaged.

### CROSS-REFERENCE TO RELATED APPLICATIONS

This application claims priority to and the benefit of Korean Patent Application No. 10-2025-0051775 filed with the Korean Intellectual Property Office on Apr. 21, 2025, the entire contents of which are incorporated herein by reference.

### TECHNICAL FIELD

The present disclosure relates to a method for controlling a structural battery for an electric vehicle, and, more particularly, the present disclosure relates to a method for controlling independent charging and discharging of a structural battery for an electric vehicle implementing a center floor panel function of a vehicle by structural battery modules.

### BACKGROUND

In general, a lithium-ion battery mounted in an electric vehicle may not perform a any load-bearing function, although the lithium-ion battery may occupy a significant portion of a weight of the electric vehicle.

On the other hand, a structural battery may be a part installed in a frame or a structure of the vehicle, and may simultaneously perform load-bearing and charging/discharging and boosting functions of a high-voltage battery installed in a floor of the vehicle body. That is, the structural battery may serve as the battery while performing the function of the vehicle structure.

This battery may be also referred to as a mass-free energy storage device. The reason is that a weight of the battery belongs to a partial weight of the load-bearing structure, and it is thus considered that there is no weight of the battery itself that stores energy. This multi-function battery may significantly reduce the weight of the vehicle. When applied to the electric vehicle, the structural battery may allow the vehicle to have an improved cruising distance due to the reduced weight.

A structural battery may have a lower capacity than that of a lithium-ion battery, i.e. a capacity of about 20% of the capacity of a lithium-ion battery. The electric vehicle may not require a separate battery, which may significantly reduce the weight of the vehicle, which may result in less energy required to drive the electric vehicle. Furthermore, the structural battery may have lower electrical energy density and higher stability.

Particularly, as shown in FIG. 1, the structural battery may be implemented to function as a center floor panel of the vehicle body. The structural battery supplies energy to the vehicle's door latch, power seat frame, emergency call system (e-Call), built-in camera, and other electrical load devices. When the structural battery is damaged because of an accident, such as a vehicle collision, it is necessary to secure a redundancy function for preventing the vehicle from shutting down due to damage to the entire structural battery, and independently supplying power to various load devices.

Particularly, the redundancy function is very important to ensure the safety of occupants in the event of a vehicle accident, such as emergency power supply and operation of auxiliary emergency braking devices.

### SUMMARY

The present disclosure attempts to provide a method for controlling a structural battery for an electric vehicle including multiple modules for providing a center floor panel of a vehicle including structural battery modules to protect some of the structural battery modules in the event of a collision and implement a redundancy function.

An embodiment of the present disclosure provides a method for controlling a structural battery for an electric vehicle, representing a method for controlling a center floor structural battery configured with structural battery modules applied to a vehicle, including: charging the respective structural battery modules; monitoring whether the respective structural battery modules are damaged; independently controlling charging and discharging of the respective structural battery modules depending on whether the respective structural battery modules are damaged; supplying electric power of the respective structural battery modules to a load device of the vehicle; monitoring whether the load device is damaged; and blocking a current flow to the respective structural battery modules when the load device is damaged.

The structural battery modules may include electrically connected battery cells, and glass fiber prepreg layers and carbon fiber prepreg layers stacked on outsides of the battery cells.

The structural battery modules may include: a center structural battery module; a first side structural battery module connected to a first lateral portion of the center structural battery module; and a second side structural battery module combined to a second lateral portion of the center structural battery module that is an opposite side of a joint portion of the first side structural battery module, and the center structural battery module, the first side structural battery module, and the second side structural battery module are combined to have a panel shape.

The center structural battery module, the first side structural battery module, and the second side structural battery module may be combined by an adhesive between matched surfaces or by a mechanical combination by bolts and rivets, and may be electrically connected in parallel to each other.

A portion of the first side structural battery module and the second side structural battery module to which respective lateral portions of the center structural battery module are combined may have a joggle shape to absorb a step of the joint portion.

The charging of the respective structural battery modules may be performed by a high voltage battery for configuring a power source of the center floor structural battery, an LDC connected to the high voltage battery and converting high voltage into low voltage, and a power relay assembly PRA connected to the LDC and blocking overvoltage and overcurrent from among the power source converted into low voltage.

The monitoring of whether the respective structural battery modules are damaged may be performed using a voltage sensor for diagnosing voltages in charging and discharging states of the structural battery modules, a temperature sensor for diagnosing temperatures in charging and discharging states of the structural battery modules, and a current sensor for diagnosing currents in charging and discharging states of the structural battery modules.

The independently controlling of charging and discharging of the respective structural battery modules depending on whether the respective structural battery modules are damaged may include: blocking charging and discharging of the corresponding structural battery module when some of the respective structural battery modules monitored to be damaged depending on whether problems are generated to the monitored voltages temperatures and currents, and continuously charging the corresponding structural battery and discharge to a load device connected thereto when the others thereof are monitored to be not damaged.

A module battery management system (MBMS) for operating an FET switch and independently controlling charging and discharging may be respectively installed in the respective structural battery modules when the corresponding structural battery module is damaged.

The MBMS may include: a cell balancing unit connected to the voltage sensor, and maintaining capacity of the battery cells by applying resistance to the battery cell having a voltage difference when charging, and a battery monitoring integrated circuit (BMIC) connected to the cell balancing unit to monitor whether overvoltage is generated, monitoring overtemperature through an micro-computer (MIC) connected to the temperature sensor, and connected to the current sensor to monitor whether overcurrent is generated to apply a charging and discharging blocking or charging and discharging operation control signal to the FET switch.

The supplying of electric power of the respective structural battery modules to a load device of the vehicle may be performed by a pack protector connected to the respective structural battery modules, supplying a power voltage supplied by the structural battery module monitored as not damaged to the load device, and preventing short-circuit according to overcurrent diagnosis of the load device.

The pack protector may include: a power terminal connected to the respective structural battery module, receiving a power voltage, and discharging the same to the load device; a load device current sensor connected to the load device and diagnosing current of the load device; and a load device FET switch connected to the load device current sensor and installed to operate a disconnected state with a power terminal depending on whether there is overcurrent diagnosed by the load device current sensor.

The monitoring of whether the load device is damaged may include diagnosing whether there is overcurrent by a load device current sensor connected to the load device and installed to diagnose the current of the load device.

The blocking of a current flow to the respective structural battery modules when the load device is damaged may include: when it is diagnosed as that there is overcurrent by the load device current sensor, applying a disconnection signal to the load device FET switch, and disconnecting a closed circuit between the pack protector and the structural battery module by the load device FET switch, and preventing short-circuit.

According to the present disclosure, by having the structural battery functioning as a battery function as the center floor panel of the vehicle, the cost and battery space may be saved, the layout may be improved, weight may be reduced, and fuel efficiency may be improved, thereby improving the marketability of the vehicle.

By implementing the redundancy function of separated and independent structural battery modules, the redundancy function is implemented by protecting some of the structural battery modules in the event of a vehicle accident, and charging and discharging may be controlled for each structural battery module, thereby ensuring the stability of the vehicle.

In the event of a vehicle accident, emergency power may be supplied to the load device even if some structural battery modules are damaged.

### BRIEF DESCRIPTION OF THE DRAWINGS

FIG. 1 shows a schematic diagram of an electric vehicle to which a structural battery module for an electric vehicle is applied according to an embodiment.

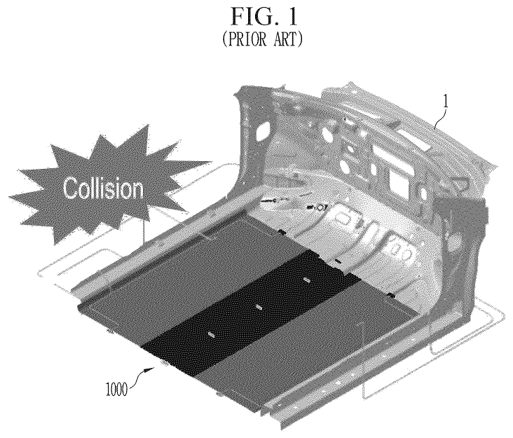

FIG. 2 shows a perspective view on an assembled state of a structural battery module for an electric vehicle according to an embodiment.

FIG. 3 shows a cross-sectional view on a process for assembling a structural battery module for an electric vehicle according to an embodiment shown in FIG. 2.

FIG. 4 shows a cross-sectional view on a state after a structural battery module for an electric vehicle is assembled according to an embodiment shown in FIG. 2.

FIG. 5 shows a schematic view on a logic for operating a structural battery center floor pack for implementing a method for controlling a structural battery for an electric vehicle according to an embodiment.

FIG. 6 shows a hardwired connection relationship of a center structural battery module configuring a structural battery for an electric vehicle according to an embodiment.

FIG. 7 shows an enlarged module battery management system (MBMS) used in a method for controlling a structural battery for an electric vehicle according to an embodiment.

FIG. 8 show a hardwired parallel connection relationship of a structural battery for an electric vehicle according to an embodiment.

FIG. 9 shows a pack protector used in a method for controlling a structural battery for an electric vehicle according to an embodiment.

FIG. 10 shows a flowchart on a method for controlling a structural battery for an electric vehicle according to an embodiment.

### DETAILED DESCRIPTION OF ILLUSTRATIVE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

With embodiments of the present disclosure, detailed description is made as to the constituent elements in the first embodiment with reference to the relevant drawings by using the same reference numerals for the same constituent elements, while the constituent elements different from those related to the first embodiment are described in other embodiments.

The drawings are schematic and are not illustrated in accordance with a scale. The relative sizes and ratios of the parts in the drawings are exaggerated or reduced for clarity and convenience in the drawings, and an arbitrary size is only exemplary and is not limited. The same structures, elements, or parts illustrated in no less than two drawings are denoted by the same reference numerals in order to represent similar characteristics. When a part is referred to as being “on” another part, it may be directly on the other part or intervening parts may also be present.

An embodiment of the present disclosure will now be illustrated in detail. As a result, various modifications are expected to be made. Therefore, the embodiment is not limited to a specific shape of an illustrated region, but, for example, includes a change in the shape in accordance with manufacturing.

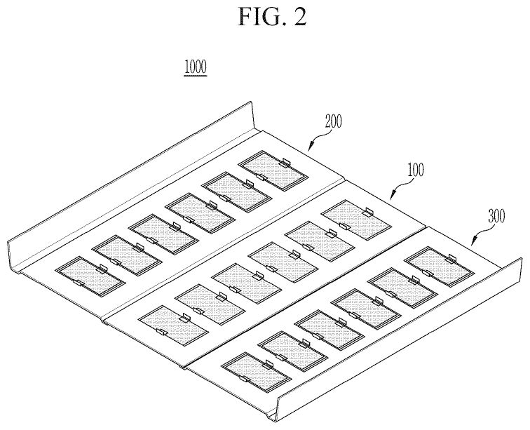

A structure of a structural battery to which a method for controlling a structural battery for an electric vehicle according to an embodiment is applied will now be described with reference to FIG. 2 to FIG. 4.

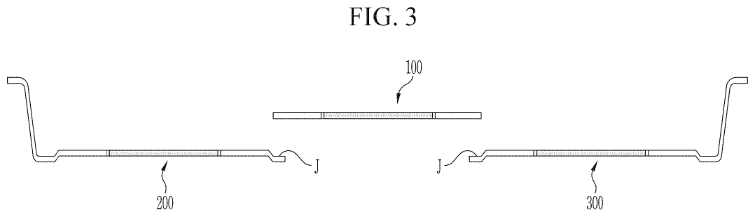

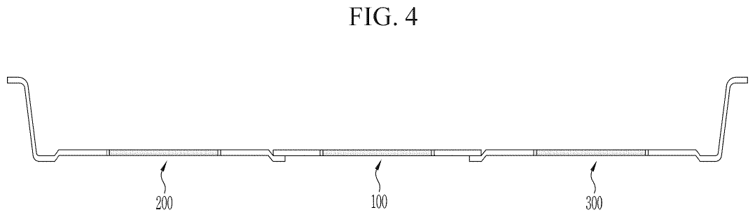

FIG. 2 shows a perspective view on an assembled state of a structural battery module for an electric vehicle according to an embodiment, FIG. 3 shows a cross-sectional view on a process for assembling a structural battery module for an electric vehicle according to an embodiment shown in FIG. 2, and FIG. 4 shows a cross-sectional view on a state after a structural battery module for an electric vehicle is assembled according to an embodiment shown in FIG. 2.

As shown in FIG. 2, the structural battery module 1000 includes a center structural battery module 100, a first side structural battery module 200, and a second side structural battery module 300.

The center structural battery module 100, the first side structural battery module 200, and the second side structural battery module 300 respectively include a battery module. The battery module may include battery cells electrically connected in series, and glass fiber prepreg layers and carbon fiber prepreg layers stacked outside the battery cells.

The first side structural battery module 200 is combined to a first lateral portion of the center structural battery module 100, and the second side structural battery module 300 is combined to a second lateral portion of the center structural battery module 100 that is an opposite side of the joint portion of the first side structural battery module 200.

The center structural battery module 100, the first side structural battery module 200, and the second side structural battery module 300 may be combined by an adhesive between matched surfaces or by a mechanical combination by bolts and rivets, and they may be electrically connected in parallel to each other. That is, the battery modules included in the center structural battery module 100, the first side structural battery module 200, and the second side structural battery module 300 may be electrically connected in series, and the battery modules among the center structural battery module 100, the first side structural battery module 200, and the second side structural battery module 300 may be electrically connected in parallel.

The center structural battery module 100 may have a quadrangular plate shape, and the first side structural battery module 200 where respective lateral portions of the center structural battery module 100 are combined to each other and the joint portion (J) (e.g., as shown in FIG. 2) that is a portion of the second side structural battery module 300 may have joggle shapes.

The joint portion (J) has the joggle shape indented from center portions of the first side structural battery module 200 and the second side structural battery module 300, so respective lateral portions of the center structural battery module 100 may be disposed on the joint portion (J), and a step between the center structural battery module 100 and the lateral structural battery modules 200 and 300 may be absorbed at the joint portion (J). Hence, the battery modules of the center structural battery module 100 and the lateral structural battery modules 200 and 300 may be arranged on the same horizontal plane.

The center structural battery module 100, the first side structural battery module 200, and the second side structural battery module 300 may be manufactured using a common module including the same battery module.

The common module may include a battery module including a battery cell on a center portion, and respective lateral portions may have the joggle shape configuring the joint portion (J). Regarding the common module, the joint portion (J) in the joggle shape may be selectively cut to configure the center structural battery module 100 and the lateral structural battery modules 200 and 300. The center structural battery module 100 may be multiple so the center structural battery modules 100 may be combined to face each other or may overlap each other.

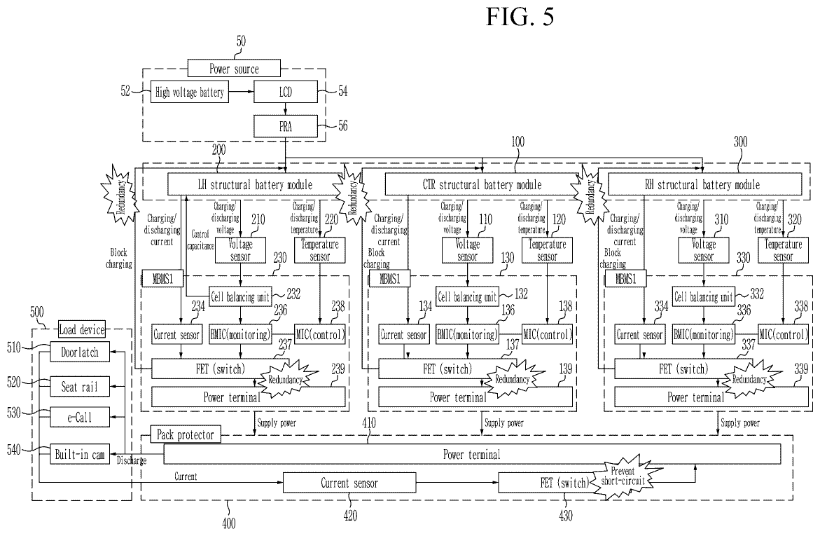

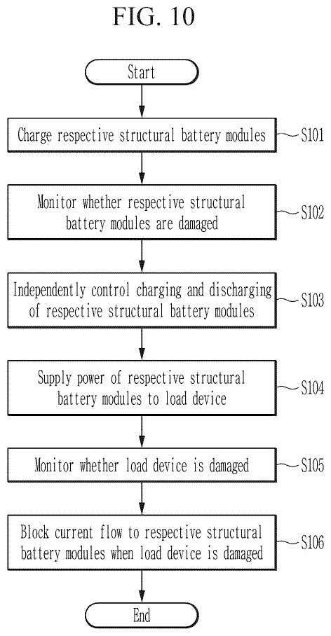

FIG. 5 shows a schematic view of logic for operating a structural battery center floor pack to implement a method for controlling a structural battery for an electric vehicle according to an embodiment, and FIG. 10 shows a flowchart of a method for controlling a structural battery for an electric vehicle according to an embodiment.

Referring to FIG. 5 and FIG. 10, the method for controlling a structural battery for an electric vehicle according to an embodiment represents a method for controlling charging and discharging of the respective structural battery modules 100, 200, and 300 of the center floor structural battery 1000 configured with structural battery modules applied to the vehicle, and the method includes charging the respective structural battery modules (Sii).

The respective structural battery modules 100, 200, and 300 are charged using a power voltage supplied by the power source 50 including a high voltage battery 52, a low Voltage DC-DC converter (LDC) 54, and a power relay assembly (PRA) 56. The power source 50 may supply the power voltage to the center structural battery module 100, the first side structural battery module 200, and the second side structural battery module 300 included in the center floor structural battery 1000.

The LDC 54 may be connected to the high voltage battery 52, may convert electrical energy stored from the high voltage battery 52 into a low voltage, and may supply a power voltage to the center floor structural battery 1000 and the load device 500. For example, the LDC 54 may receive electric power of about 360V from the high voltage battery 52, may convert it into a low voltage of about 12V, and may supply it as a power voltage.

The power relay assembly 56 may be connected to the LDC 54, and may block overvoltage and overcurrent from among the power source converted into a low voltage by the LDC 54. When overcurrent flows into the battery or an electrical leakage is generated in a wire, a switch in the power relay assembly 56 may be disconnected to block the electricity of the battery.

While charging the respective structural battery modules, damaging states of the structural battery modules are monitored (S102).

The damaging states of the respective structural battery modules 100, 200, and 300 may be monitored using voltage sensors 110, 210, and 310, temperature sensors 120, 220, and 320, and current sensors 134, 234, and 334 in the structural battery modules 100, 200, and 300. The voltage sensors 110, 210, and 310 may be installed to diagnose voltages of charging and discharging states of the structural battery modules 100, 200, and 300, the temperature sensor 120, 220, and 320 may be installed to diagnose temperatures of charging and discharging states of the structural battery modules 100, 200, and 300, and the current sensors 134, 234, and 334 may be installed to diagnose currents of charging and discharging states of the structural battery modules 100, 200, and 300.

Charging and discharging of the respective structural battery modules are independently controlled according to the damaging state of the structural battery modules (S103).

When some of the structural battery modules 100, 200, and 300 are determined (e.g., via the monitoring) to be damaged depending on whether the voltages, the temperatures, and the currents monitored using the voltage sensors 110, 210, and 310, the temperature sensors 120, 220, and 320, and the current sensors 134, 234, and 334 installed in the structural battery modules 100, 200, and 300 have generated problems, charging and discharging of the corresponding structural battery module is controlled to be blocked. The structural battery module that is monitored as not damaged from the structural battery modules 100, 200, and 300 continues being charged, and charged electric power is discharged to the load device 500 connected to the corresponding structural battery module.

The electric power of the continuously-charged structural battery modules is supplied to the load device of the vehicle (S104). The electric power of the structural battery modules 100, 200, and 300 is supplied to the load device 500 by the pack protector 400. The pack protector 400 includes a power terminal 410 connected to the structural battery modules 100, 200, and 300 and receiving power and dividing the same to the load device 500.

In one or more examples, monitoring of the load device 500 is performed to determine whether the load device 500 is damaged while electric power of the respective structural battery modules is supplied to the load device of the vehicle (S105). When the load device is determined to be damaged, the current flow to the respective structural battery modules is blocked (S106).

To achieve this, the pack protector 400 may include: a power terminal 410 connected to the structural battery modules 100, 200, and 300, receiving power voltage, and discharging the same to the load device 500; a load device current sensor 420 connected to the load device and diagnosing the current of the load device; and a load device FET switch 430 connected to the load device current sensor 420 and installed whether to operate a disconnection state with the power terminal 410 depending on the overcurrent diagnosed by the load device current sensor 420.

The monitoring of whether the load device 500 is damaged in S1o5 may include: when the overcurrent is diagnosed to flow at the load device current sensor 420, applying a disconnection signal to the load device FET switch 430 to disconnect a closed circuit between the pack protector 400 and the structural battery modules 100, 200, and 300 by the load device FET switch 430 and prevent short-circuit.

As described, while the structural battery modules 100, 200, and 300 are being charged, damaged states of the structural battery modules 100, 200, and 300 are monitored, the structural battery module monitored as not damaged continues being charged, and the structural battery module monitored as damaged is controlled to block charging and discharging.

The electric power of the charging-continued structural battery module is discharged to the load device 500, during which it is monitored whether the load device 500 is damaged, and when the load device 500 is monitored as damaged, the current flows to the respective structural battery modules 100, 200, and 300 are blocked and the short-circuit may be prevented.

As described, a redundancy function of the separated and independent structural battery modules 100, 200, and 300 may be implemented, and charging and discharging for the respective structural battery modules 100, 200, and 300 may be controlled according to the damaged states of the structural battery modules 100, 200, and 300 and the load device 500 caused by accidents of the vehicle, thereby securing stability of the vehicle.

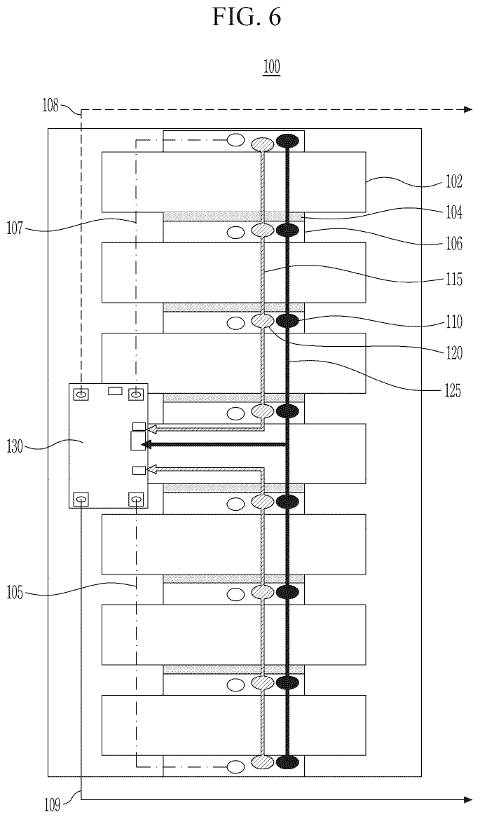

FIG. 6 shows a hardwired connection relationship of a center structural battery module configuring a structural battery for an electric vehicle according to an embodiment.

As shown in FIG. 6, the center structural battery module 100 includes adjacent battery cells 102, and electrode tabs 104 and 106 electrically connected to the battery cells 102 are connected to each other. A voltage sensor 110 and a temperature sensor 120 are installed in the electrode tab 106, the voltage sensors 110 are connected together by a voltage sensor wire 125, and the temperature sensors 120 are connected together by a temperature sensor wire 115.

The voltage and temperature information diagnosed by the voltage sensor 11o and the temperature sensor 120 are transmitted to the module battery management system (MBMS) 130 through wiring 125 and 115.

A cell module input terminal 107 and a cell module output terminal 108 connected to the electrode tab 106 are installed in the MBMS 130.

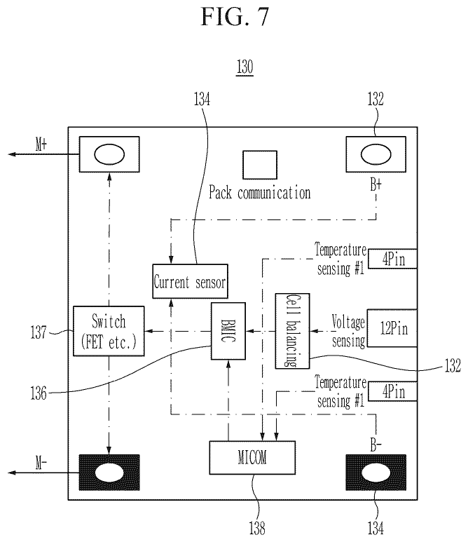

FIG. 7 shows an enlarged module battery management system (MBMS) used in a method for controlling a structural battery for an electric vehicle according to an embodiment.

As shown in FIG. 7, the MBMS 130 includes: a cell balancing unit 132 connected to the voltage sensor no, and applying resistance to the battery cell generating a voltage difference at the time of charging to maintain capacity of the battery cells; a MIC 138 monitoring a balanced voltage, and connected to the temperature sensor 120 to monitor over-temperature; and a BMIC 136 applying a charging and discharging signal or a charging and discharging operation control signal to the FET switch 137.

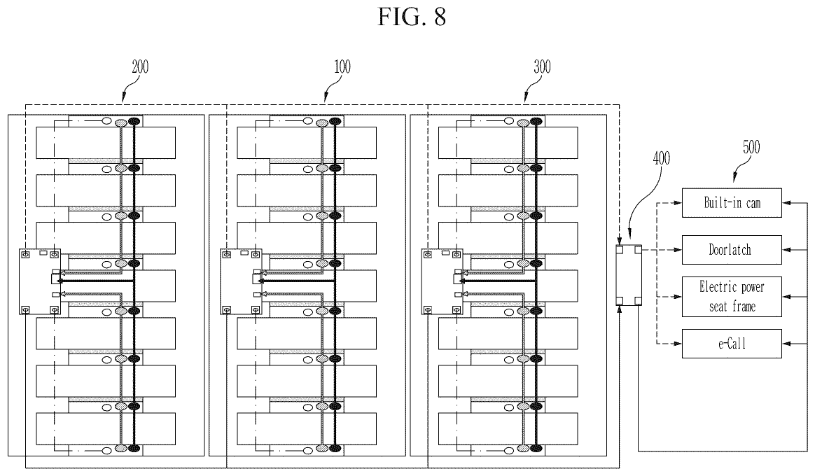

FIG. 8 shows a hardwired parallel connection relationship of a structural battery for an electric vehicle according to an embodiment.

As shown in FIG. 8, the respective structural battery modules 100, 200, and 300 may have the same structure as the center structural battery module 100 described with reference to FIG. 6, and the MBMS 130, 230, and 330 installed in the structural battery modules 100, 200, and 300 may transmit electric power of the structural battery modules 100, 200, and 300 to the pack protector 400 through the cell module output terminal 108.

The pack protector 400 may supply electric power to the load device 500 of the vehicle, such as a built-in cam, a doorlatch, a power seat frame, and an e-Call.

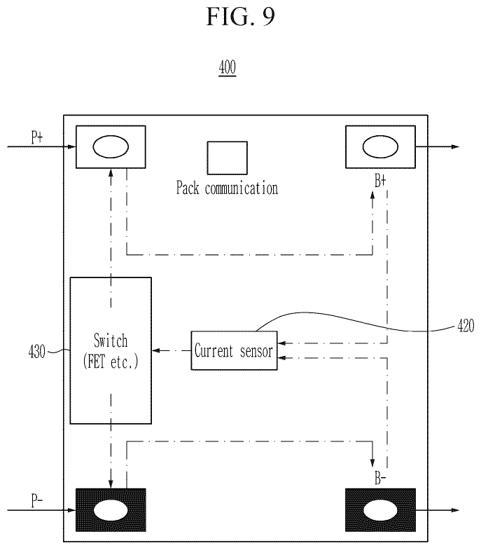

FIG. 9 shows a pack protector used in a method for controlling a structural battery for an electric vehicle according to an embodiment.

As shown in FIG. 9, the pack protector may include: a power terminal 410 connected to the structural battery modules 100, 200, and 300, receiving electric power, and discharging the same to the load device 500; a load device current sensor 420 diagnosing current of the load device 500; and a load device FET switch 430 connected to the load device current sensor 420 and installed to be operated whether to be disconnected from the power terminal 410 according to the overcurrent state diagnosed at the load device current sensor 420.

Electric power of the structural battery modules 100, 200, and 300 are input to an input terminal of the pack protector 400, it passes through the load device FET switch 430 through the load device current sensor 420, and it is transmitted to the load device 500 through an output terminal of the pack protector 400.

When it is diagnosed as a damage of the load device 500 caused by vehicle collision by the load device current sensor 420, the load device FET switch 430 may be blocked to prevent the current from flowing to the input terminal of the protector 400, thereby preventing the overcurrent from flowing to the structural battery modules 100, 200, and 300.

As described, according to the present disclosure, the structure battery functioning as the battery is allowed to function as a center floor panel of the vehicle, thereby reducing expenses and battery spaces, improving the layout, reducing the weight, and improving fuel efficiency, and resultantly improving commercial values of the vehicle.

By implementing the redundancy function of the separated and independent structural battery modules, some of the structural battery modules may be protected when the vehicle has an accident to implement the redundancy function, and may control charging and discharging for the respective structural battery modules, thereby securing stability of the vehicle.

In the event of the vehicle accident, when some of the structural battery modules is damaged, emergency electric power may be supplied to the load device.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1000: center floor structural battery
100: center structural battery module
200: first side structural battery module
300: second side structural battery module
50: power source
52: high voltage battery
54: LDC
56: power relay assembly PRA
110, 210, 310: voltage sensor
120, 220, 320: temperature sensor
134, 234, 334: current sensor
137, 237, 337: FET switch
130, 230, 330: module battery management system MBMS
132, 232, 332: cell balancing unit
138, 238, 338: MIC
136, 236, 336: BMIC
400: pack protector
410: power terminal
420: load device current sensor
430: load device FET switch
500: load device

What is claimed is:

1. A method for controlling a structural battery for an electric vehicle, the method comprising:
charging respective structural battery modules of the electric vehicle;
monitoring whether any of the respective structural battery modules are damaged;
independently controlling charging and discharging of the respective structural battery modules depending on whether the respective structural battery modules are damaged;
supplying electric power of the respective structural battery modules to a load device of the electric vehicle;
monitoring whether the load device is damaged; and
blocking a current flow to the respective structural battery modules when the load device is damaged.

2. The method of claim 1, wherein the respective structural battery modules each comprise:
electrically connected battery cells; and
glass fiber prepreg layers and carbon fiber prepreg layers stacked on outsides of the respective battery cells.

3. The method of claim 2, wherein:
the respective structural battery modules comprise:
a center structural battery module;
a first side structural battery module connected to a first lateral portion of the center structural battery module; and
a second side structural battery module connected to a second lateral portion of the center structural battery module that is an opposite side of a joint portion of the first side structural battery module, and
the center structural battery module, the first side structural battery module, and the second side structural battery module are combined to have a panel shape.

4. The method of claim 3, wherein:
the center structural battery module, the first side structural battery module, and the second side structural battery module are combined by an adhesive between matched surfaces or by a mechanical combination by bolts and rivets, and are electrically connected in parallel to each other.

5. The method of claim 4, wherein:
a portion of the first side structural battery module and the second side structural battery module to which respective lateral portions of the center structural battery module are combined has a joggle shape to absorb a step of the joint portion.

6. The method of claim 1, wherein charging the respective structural battery modules is performed by:
a high voltage battery for configuring a power source of a center floor structural battery;
a low voltage DC-DC converter (LDC) connected to the high voltage battery and converting high voltage into low voltage; and
a power relay assembly power relay assembly (PRA)connected to the LDC and blocking overvoltage and overcurrent from among the power source converted into low voltage.

7. The method of claim 6, wherein monitoring whether the respective structural battery modules are damaged is performed using:
a voltage sensor for monitoring voltages in charging and discharging states of the respective structural battery modules,
a temperature sensor for monitoring temperatures in charging and discharging states of the respective structural battery modules, and
a current sensor for monitoring currents in charging and discharging states of the respective structural battery modules.

8. The method of claim 7, wherein independently controlling charging and discharging of the respective structural battery modules depending on whether the respective structural battery modules are damaged includes:
blocking charging and discharging of a structural battery module of the respective structural battery modules when the structural battery module is determined to be damaged based on the voltages monitored by the voltage sensor, the temperatures monitored by the temperature sensor, and currents monitored by the current sensor, and
continuously charging a second structural battery module of the respective structural battery modules and discharging to a load device connected thereto when the second structural battery module is determined to be not damaged.

9. The method of claim 8, wherein:
a module battery management system (MBMS) for operating a field effect transistor (FET) switch and independently controlling charging and discharging is respectively installed in the respective structural battery modules when the structural battery module is damaged.

10. The method of claim 9, wherein the MBMS includes:
a cell balancing unit connected to the voltage sensor, and maintaining capacity of battery cells by applying resistance to the battery cells having a voltage difference when charging, and
a battery monitored integrated circuit (BMIC) connected to the cell balancing unit to monitor whether overvoltage is generated, monitoring overtemperature through a micro-computer (MIC) connected to the temperature sensor, and connected to the current sensor to monitor whether overcurrent is generated to apply a charging and discharging blocking or charging and discharging operation control signal to the FET switch.

11. The method of claim 10, wherein supplying the electric power of the respective structural battery modules to the load device of the electric vehicle is performed by a pack protector connected to the respective structural battery modules, supplying a power voltage supplied by the second structural battery module determined to be not damaged to the load device, and preventing short-circuit according to overcurrent diagnosis of the load device.

12. The method of claim 11, wherein the pack protector includes:
a power terminal connected to the respective structural battery modules, receiving a power voltage, and discharging the power voltage to the load device;
a load device current sensor connected to the load device and diagnosing current of the load device; and
a load device FET switch connected to the load device current sensor and installed to operate a disconnected state with a power terminal depending on whether there is overcurrent diagnosed by the load device current sensor.

13. The method of claim 12, wherein monitoring whether the load device is damaged includes:
diagnosing whether there is overcurrent by the load device current sensor connected to the load device and installed to diagnose the current of the load device.

14. The method of claim 13, wherein blocking the current flow to the respective structural battery modules when the load device is damaged includes:
when it is diagnosed as that there is overcurrent by the load device current sensor, applying a disconnection signal to the load device FET switch, and disconnecting a closed circuit between the pack protector and the structural battery module by the load device FET switch, and preventing short-circuit.

15. A system for controlling a structural battery of an electric vehicle, the system comprising:
the structural battery, comprising:
a first structural battery module comprising a first module battery management system (MBMS); and
a second structural battery module comprising a second MBMS;
a power source configured to charge the first structural battery module and the second structural battery module;
a load device configured to receive power from the first structural battery module and the second structural battery module;
a first plurality of sensors configured to monitor a first state of the first structural battery module to determine whether the first structural battery module is damaged; and
a second plurality of sensors configured to monitor a second state of the second structural battery module to determine whether the second structural battery module is damaged,
wherein, when a determination is made, based on the first plurality of sensors, that the first structural battery module is damaged:
the first MBMS is configured to block charging and discharging of the first structural battery module; and
the second MBMS is configured to continue charging and discharging of the second structural battery module, and
the load device stops receiving power from the first structural battery module and continues to receive the power from the second structural battery module.

16. The system of claim 15, wherein:
the first structural battery module comprises a joint portion located at a first structural battery module side,
the second structural battery module comprises a joggle shape portion located at a second structural battery module side, and
the joint portion is connected to the joggle shape portion to join the first structural battery module and the second structural battery module such that a first surface of the first structural battery module and a second surface of the second structural battery module form a planar surface.

17. The system of claim 15, wherein:
the first plurality of sensors comprises:
a voltage sensor configured to monitor a voltage of the first structural battery module;
a current sensor configured to monitor a current of the first structural battery module; and
a temperature sensor configured to monitor a temperature of the first structural battery module, and
the determination that the first structural battery module is damaged is based on one or more outputs of at least one of the voltage sensor, the current sensor, and the temperature sensor.

18. A method for controlling a structural battery of an electric vehicle, the method comprising:
performing charging of a first structural battery module and a second structural battery module of the structural battery;
supplying power to a load device from the first structural battery module and the second structural battery module;
making a first determination that the first structural battery module is damaged;
stopping, based on the first determination, the charging of and discharging from the first structural battery module; and
continuing, while the charging of and discharging from the first structural battery module is stopped, to supply the power to the load device from the second structural battery module.

19. The method of claim 18, further comprising, while continuing to supply the power to the load device from the second structural battery module:
making a second determination that the load device is damaged; and
blocking, based on the second determination, any current flow from the load device to the second structural battery module.

20. The method of claim 18, wherein supplying the power to the load device form the first structural battery module and the second structural battery module is performed by a pack protector connecting the first structural battery module and the second structural battery module to the load device.
